(19) United States
(12) Patent Application Publication
(10) Pub. No.: US 2005/0139492 A1
(43) Pub. Date: Jun. 30, 2005

(54) Method for detecting trace amount of matters by using pulsed voltammetry

(75) Inventors: Shan-Shan Chou, Hsinchu County (TW); Shu-Fang Hsu, Hsinchu City (TW); Pau-Yee Lin, Hsinchu County (TW); Hsuan-Chin Lai, Hsinchu City (TW); Jung-Chou Oung, Hsinchu County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 10/859,216

(22) Filed: Jun. 3, 2004

(30) Foreign Application Priority Data
Dec. 24, 2003 (TW) 92136694

(51) Int. Cl. G01N 27/26

(52) U.S. Cl. 205/787; 205/790

(57) ABSTRACT

An electrochemical method is provided, whereby electrodes are coated with conductive diamond film material. The method detects the concentration of metal ions and organic compounds in solutions by using square wave voltammetry of pulsed voltammetry. Since the electrodes coated with conductive diamond film material enable the user to obtain broader range of voltage measurement, the number of chemicals detected is greatly increased and the accuracy thereof improved.

### BACKGROUND OF THE INVENTION

1. Field of the Invention

The present invention relates to an electrochemical analysis method to detect the concentration of heavy metal and organic material in a solution using the conductive diamond film material as the electrodes associated with the square wave voltammetry.

2. Description of Related Art

Following the increased attention on the environmental protection concept, every country increasingly pays more attention on the influence of environmental hormone to the human body functions. The so-called hormone includes the pesticides, the organic matters containing chlorine, and heavy metal. These products brought by heavily industrial development will cause great damages to the human body and the ecological environment. Currently, the detection for the metal matter has to employ the AA (Atomic Absorption Spectrum) and ICP (Induced Coupling Plasma). For different chemical and biomedical matters analysis, such as organic matters containing chlorine, the detection employs the gas chromatography, liquid chromatography, mass spectrometry, and other analysis method. However, most of these equipments are expensive and time-consuming.

The electrochemical detection method can provide more economic, convenient, and power-saving measurement manner, but the conventional electrodes (such as noble metal, graphite carbon, and conductive oxide) still have many problems to be solved. For example, the range of voltage measurement for noble metal electrode is not so wide, that the measurable matters are limited. And, the conventional carbon electrodes have the problem of reduced surface reaction activity after repetitive use.

Recently, because of the rapid growth of electronic communication industry, the diamond film becomes the major focus of research and development in the semiconductor application. Many organizations joined the research related to the diamond film in the past twenty years, so that the technical development of diamond film is very fast. The diamond has the sp³ electron structure and is intuitively highly insulative material. Because it has multiple characteristics, such as highly thermal conductive, high strength, abrasive endurance, thermal endurance, if it is doped with boron ions in IIIA group, it can provide the conductive feature with the original physical and chemical characteristics, so-called B-doped diamond, which is a conductive diamond (p-type Conductive Diamond Electrode, p-type CDE). If it is doped with nitrogen or phosphorous in VA group, so-called N-doped or P-doped diamond, it is also a conductive diamond (n-type Conductive Diamond Electrode, n-type CDE), and has a broader application range. The conductive diamond film is p-type or n-type doping diamond film. Currently, the chemical vapor deposition (CVD) is still the major production method for the conductive diamond film, wherein the substrate surface made of Si and coated as B-doped diamond film is the mature technique. Making an example of B-doped diamond film, usually 0.5% CH₄ (in H₂) is used as the vapor agent, the boron doping agent is mostly the diborane and boronoxide. The production methods for CDE material include the plasma enhanced chemical vapor deposition (PE-CVD), hot-filament CVD (HF-CVD), and the electron assisted CVD (EA-CVD). There are only few research organizations in the world having such kind of production techniques, as shown in FIG. 1, which shows an image of polycrystalline B-doped conductive diamond film observed by the electron microscope.

In the electrochemical application, the better the conductivity of metal substrate for the electrode is, the lower the power consumption is. For the electrode substrate under severe environment, the material should be able to endure etched. Some researches had indicated that the production of diamond film electrode should be conducted in the high temperature processing, so that it is better to choose the metal with higher melting point as the substrate, such as Zr, Mo, Ta, W. The conductive diamond electrodes further become interested due to its unique electrochemical performance, such as having higher overvoltage, stronger anti-poison capability, and excellent strength and better anti-erosion. The potential application for the electrochemical characteristics of CDE is very wide. For example, because it has wide and stable potential window for the aqueous solution, it can solve the electrochemical interference problem generated by the electrolysis reaction of water in the past. Also, because the high surface drainage on the conductive diamond film electrode, it can continuously keep the activation function without surface poison by attaching with pollutants, and have higher application endurance. Thus, the conductive diamond film electrode has very much industrial application value. Currently, the known application range for CDE include the detection of organic solvent and heavy metal, oxidation of organic solvent, reduction removal of hazardous heavy metal, electrochemical processing for producing nano-metal particles, biochemical sensing elements, and energy storage material.

The CDE technique in electrochemical application is developed toward higher electrode conductivity. Except of B-doped p-type diamond film, the n-type diamond film in VA group is larger than the atomic p-type diamond film in IIIA group due to the larger core attraction force, so that it has smaller energy level and thus higher conductivity. The N-doped and P-doped diamond films are also being studied by researchers, but such electrode production technique is still under development in the world. For the techniques in the previous applications, such as the European Patent No. 1055926, although they employed the conductive diamond film electrodes for the detection of trace amount of matters, the employed electrochemical methods are based on the cyclic voltammetry or differential pulsed voltammetry, which do not have required precision and sensitivity, and need longer time. Thus, it is a domain required to be developed for the associated techniques of electrochemical analysis using various conductive diamond film electrode.

### SUMMARY OF THE INVENTION

To address on the drawbacks of conventional techniques, in order to increase the industrial applications of the conductive diamond film electrode, the present invention employs the conductive diamond film electrode associated with the square wave voltammetry (SWV) of pulsed voltammetry for the detection of heavy metal and organic matters in a solution.

The object of the present invention is to provide a method for detecting trace amount of matters using pulsed voltammetry, comprises the steps of: providing a working electrode and a reference electrode, wherein the material of the working electrode is a conductive diamond film electrode; immersing the working electrode and the reference electrode into a solution; sweeping the potential of the working electrode to the potential of more negative than the balance potential for the trace amount of matters in the solution; conducting positive sweeping on the potential of the working electrode using the square wave voltammetry of pulsed voltammetry (PV); and recording the amount of current occurred during potential change to detect the concentration of trace amount of matters in the solution.

The substrate for the conductive diamond film electrode comprises, but not limited to, Ti, Si, Zr, Mo, Ta, W, or other metal or alloy, wherein it is preferably to use Ti as the substrate.

Another object of the present invention is to provide a method for detecting trace amount of matters using pulsed voltammetry, comprising using the conductive diamond film electrode associated with the square wave voltammetry (SWV) of pulsed voltammetry to detect the concentration of heavy metal and/or organic matters in the solution, wherein the detection conditions for the square wave voltammetry (SWV) include: the pulsed frequency (f) is 30˜150 Hz; the pulse potential difference (ΔEₚ) is 20˜150 mV; the step potential difference (ΔE_{S}) is 2˜10 mV; and, the pH value is 4˜7.

Using conductive diamond film electrode associated with the square wave voltammetry (SWF) of pulsed voltammetry (PV) to detect the concentration of heavy metal and organic matters in the solution can reduce the background current, increase the detection sensitivity, and the surface activity after repetitive use will not be changed too much. Thus, using the conductive diamond film electrode can develop the portable electrochemical detector for super-micro amount of chemical matters which has wider detection range, higher precision and can be repetitively used, and it can effectively improve the problems of expensive and hard to carry for the vapor layer analyzer, liquid layer analyzer, mass spectrometer, or atomic absorption spectrometer.

### BRIEF DESCRIPTION OF THE DRAWINGS

FIG. 1 is the polycrystalline B-doped conductive diamond film observed by the electron microscope.

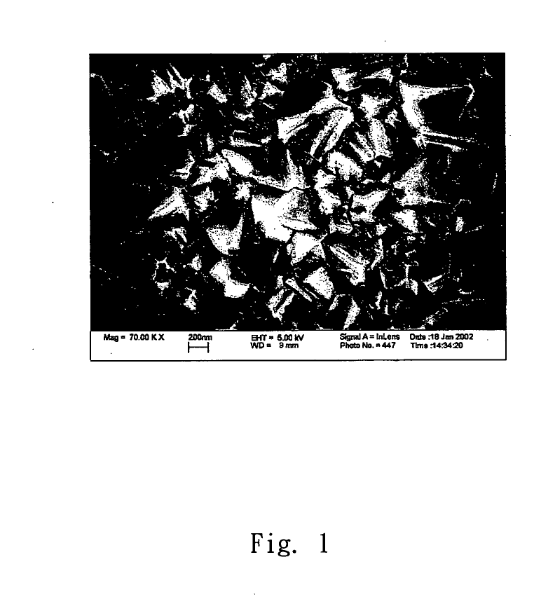

FIG. 2 is an electrochemical analysis diagram using conductive diamond film electrodes associated with the cyclic voltammetry (CV) for the detection using acetic acid as the blank solution.

FIG. 3 is an electrochemical analysis diagram using conductive diamond film electrodes associated with the square wave voltammetry (SWV) for the detection of Pb-ion concentration in the solution.

FIG. 4 is an electrochemical analysis diagram using conductive diamond film electrodes associated with the cyclic voltammetry (CV) for the detection of Zn-ion concentration in the solution.

FIG. 5 is an electrochemical analysis diagram using conductive diamond film electrodes associated with the differential pulsed voltammetry (DPV) for the detection of Zn-ion concentration in the solution.

FIG. 6 is an electrochemical analysis diagram using conductive diamond film electrodes associated with the square wave voltammetry (SWV) for the detection of Zn-ion concentration in the solution.

FIG. 7 is an electrochemical analysis diagram using conductive diamond film electrodes associated with the square wave voltammetry (SWV) for the detection of Cu-ion concentration in the solution.

FIG. 8 is an electrochemical analysis diagram using conductive diamond film electrodes associated with the square wave voltammetry (SWV) for the detection of Hg-ion concentration in the solution.

FIG. 9 is an electrochemical analysis diagram using conductive diamond film electrodes associated with the square wave voltammetry (SWV) for the detection of Ag-ion concentration in the solution.

FIG. 10 is an electrochemical analysis diagram using conductive diamond film electrodes associated with the square wave voltammetry (SWV) for the detection of pentachlorophenol concentration in the solution.

### DETAILED DESCRIPTION OF THE INVENTION

The present invention provides an electrochemical analysis method using the conductive diamond film electrode, which employs a conductive diamond film electrode as the working electrode. The method includes the following steps: the conductive diamond film working electrode is immersed into a solution to be analyzed with a reference electrode; first sweeping the potential of the working electrode to the potential more negative than the balance potential to deposit the active species in the analyzed solution on the surface of the working electrode; after completion of the deposition step, sweep the potential of the working electrode toward positive in pulse mode and the active species deposited on the electrode surface will be stripped and solved; recording the current amount during stripping of active species by changing the potential; and, by establishing the measurement line for the concentration of the active species, detecting the unknown concentration of the active species.

The conductive diamond film electrode uses the chemical vapor deposition (CVD) to form the diamond film on the substrate surface. The chemical deposition method has many types, including the plasma enhanced chemical vapor deposition (PE-CVD), the hot-filament CVD (HF-CVD), or the electron assisted CVD (EA-CVD).

The present invention uses the Ti as the substrate for the chemical deposition of the diamond film. The diamond film is the p-type or n-type doping diamond film. The p-type conductive diamond film electrode is B-doped conductive diamond film electrode, and the n-type conductive diamond film electrode is P-doped conductive diamond film electrode or N-doped conductive diamond film electrode.

The active species for electrochemical analysis using conductive diamond film electrode are the metal or organic composite, wherein the metal is the common heavy metal in the water, such as Pb, Zn, Cu, Ag, Hg; and the organic compound is the organic chemical matters with electrochemical characteristics, such as pentachlorophenol, trichloroethylene, phenol, and acrylonitrile.

The term “sweeping” in the present invention refer to define the potential of the reference electrode in the electrochemical instrument as zero (“0”). The potential of the working electrode lower than the reference electrode means the potential is negative, and the potential of the working electrode higher than the reference electrode means the potential is positive. When the working electrode has the more negative potential than the balance potential of the matters to be detected, it will proceed with the reduction reaction, and the matters to be detected will be deposited or attached on the surface of the working electrode. During the detection, if the potential of the working electrode is continuously increased, it is called the positive sweeping; on the contrary, if the potential of the working electrode is continuously reduced, it is called the negative sweeping. When the potential of the working electrode is continuously increased for the positive sweeping, the matters to be detected will generate a stripping current when the potential of the working electrode is changed to pass the balance potential.

The sweeping of the working electrode potential toward more negative than the balance potential is used for the detected trace amount of matters deposited or attached on the electrode surface, and the disolved oxygen in the water will conduct the irreversible reduction reaction at the same time. The analysis of active species is to sweep the potential of the working electrode to the potential more negative than the balance potential; to deposit the active species in the analyzed solution on the surface of the working potential; and, to conduct the positive sweeping in the pulsed manner after the completion of the deposition step; wherein the conduction of positive sweeping in the pulsed manner is to use the square wave voltammetry of pulsed voltammetry for oxidizing and stripping the active species deposited on the conductive diamond film electrode toward the positive potential, and scanning the anodic stripping current.

When using the conductive diamond film electrode associated with the square wave voltammetry for the electrochemical analysis, the pulsed frequency (f) is preferably at 30˜150 Hz, and the setting of pulse potential difference (ΔEₚ) is preferably at 20˜150 mV; the step potential difference (ΔE_{S}) is preferably at 2˜10 mV; and, the pH value of the solution suitable for the electrochemical analysis using conductive diamond film electrode associated with the square wave voltammetry is preferably at 4˜7.

The following examples are used to further understand the advantages in the present invention, but not to limit the claims of the present invention.

### EXAMPLE 1

### Analysis of Pb-Ion Concentration Using Conductive Diamond Film Electrode

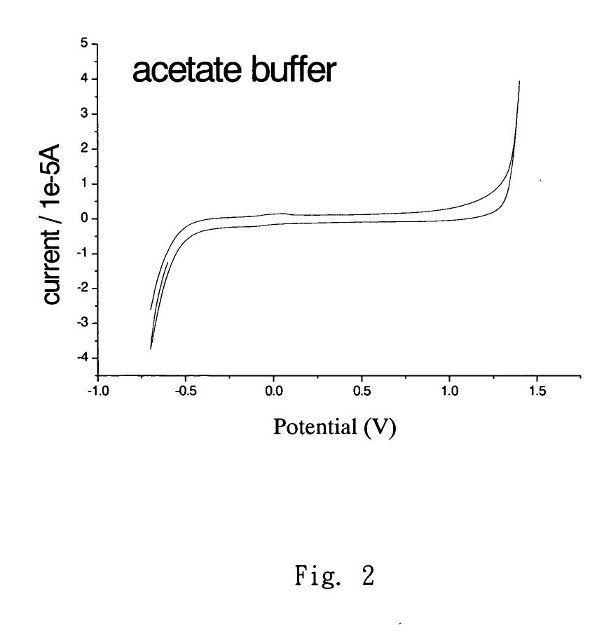

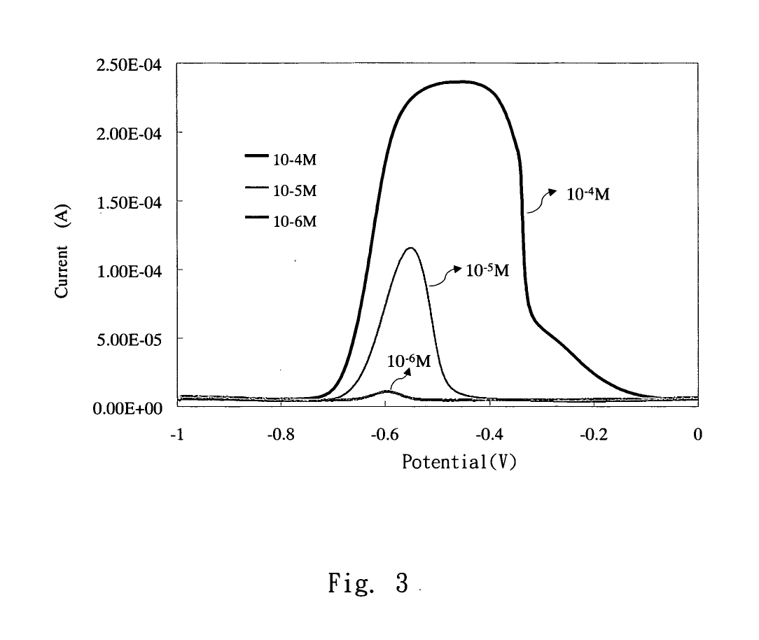

FIG. 2 illustrates the background current for using the cyclic voltammetry (CV) in the blank test of the conductive diamond film electrode, wherein the potential range without current is between −0.5˜1.3V, which is the potential range using CV for CDE detection. FIG. 3 is an electrochemical analysis diagram illustrates using the conductive diamond film electrode associated with the square wave voltammetry (SWV) to detect the Pb-ion solution with the concentration between 10⁻⁴M, 10⁻⁵M, and 10⁻⁶M, wherein the oxidation current for the Pb ions is appeared at the potential about −0.6V. As shown in the figure, during detection using the pulsed voltammetry, the initial potential is −1.0V, which is far negative than the potential limit (−0.5V) in the pulsed voltammetry. The reason is that when using negative potential for reduction of Pb ions for a period of time (referred as accumulation time) and conducting the accumulation step for 180 seconds, the dissolved oxygen in the water will conduct the irreversible reduction action at the same time. Thus, the background current of the pulsed voltammetry is small, and will be appeared at very low concentration. Therefore, using the pulsed voltammetry can greatly improve the detection sensitivity than the cyclic voltammetry.

### EXAMPLE 2

### Analysis of Zn-Ion Concentration Using Conductive Diamond Film Electrode

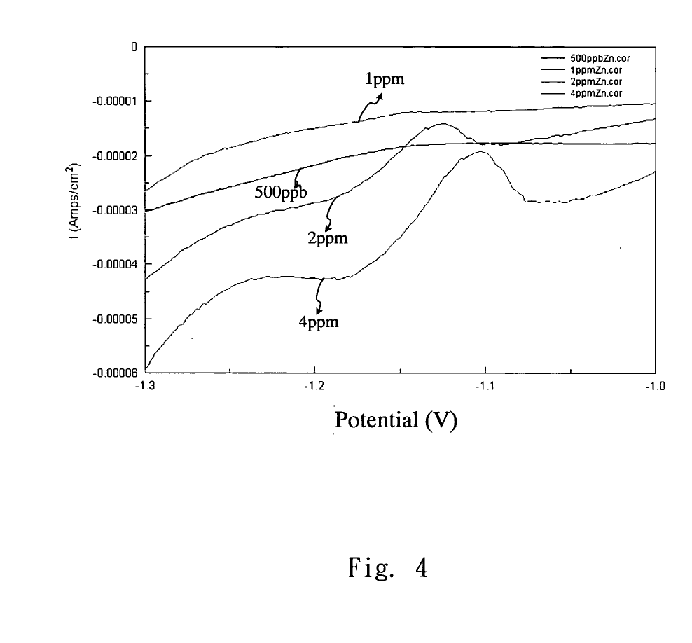

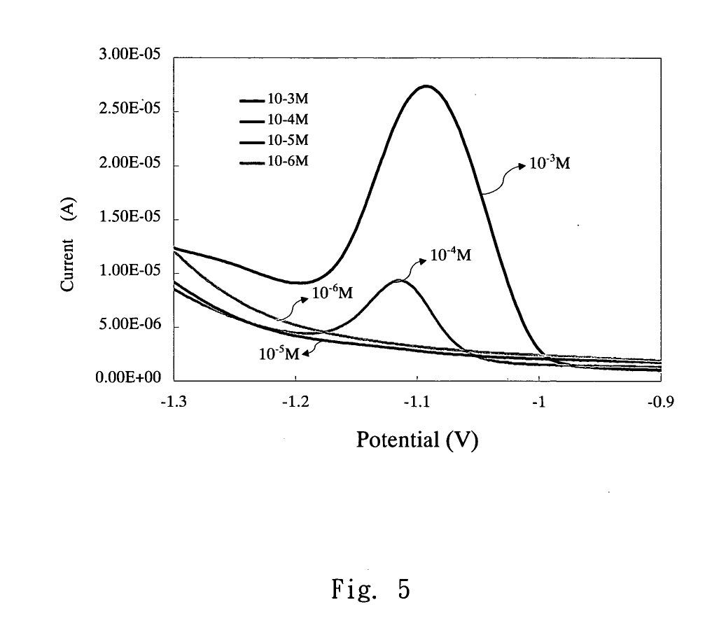

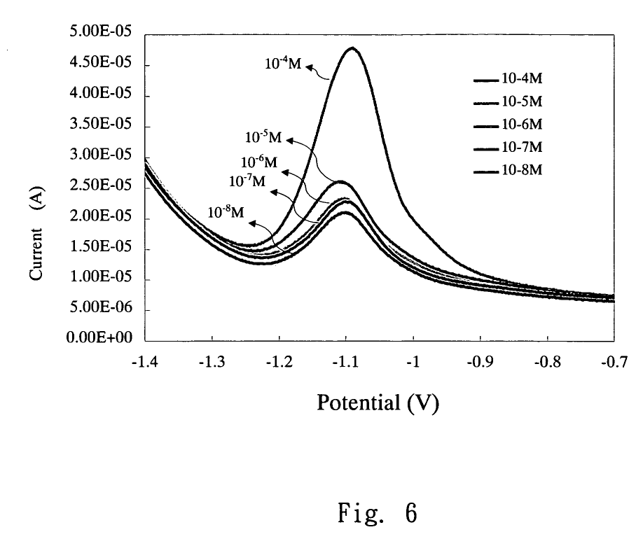

FIG. 4, FIG. 5 and FIG. 6 illustrates using conductive diamond film electrodes respectively associated with the cyclic voltammetry (CV), the differential pulsed voltammetry (DPV), and the square wave voltammetry (SWV) to detect the Zn ions in the concentration range between 1.0 mM (65 ppm) and 10 nM (0.65 ppb). After the reduction of Zn ions at negative potential (accumulation time for 180 seconds), it will conduct the anodic stripping toward the positive potential, and scan the anodic stripping current, wherein the concentration limit of detection by the cyclic voltammetry is 2 ppm, for the differential pulsed voltammetry is 6.5 ppm (10⁻⁴M), and the highest detection sensitivity provided by the waveform of the square wave voltammetry is 0.00065 ppm (10⁻⁸M).

### EXAMPLE 3

### Analysis of Cu-Ion Concentration Using Conductive Diamond Film Electrode

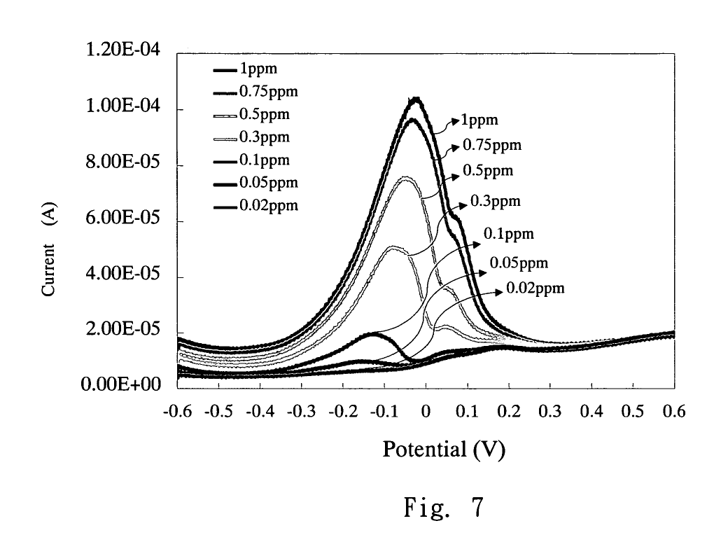

FIG. 7 is an electrochemical analysis diagram illustrating using conductive diamond film electrodes associated with the square wave voltammetry (SWV) to detect the Cu-ion solution in the concentration range between 1.0⁻⁴M and 10⁻⁶M, wherein the Cu-ion oxidation current appears at the potential about −0.1V.

### EXAMPLE 4

### Analysis of Hg-Ion Concentration Using Conductive Diamond Film Electrode

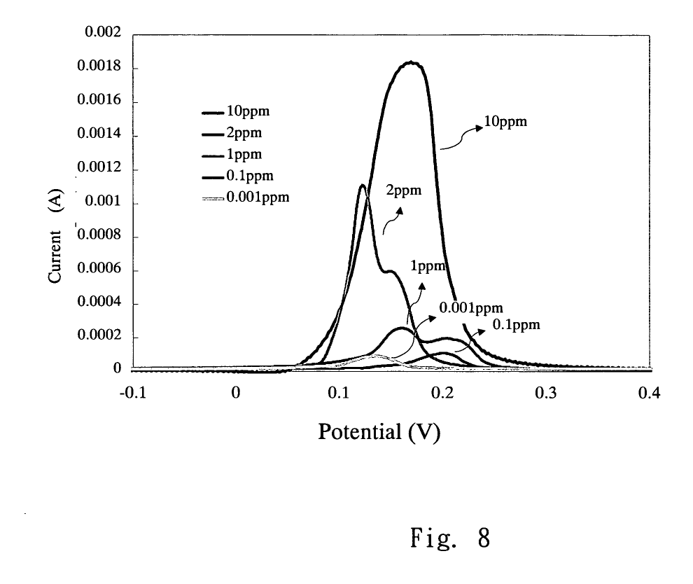

FIG. 8 is an electrochemical analysis diagram illustrating using conductive diamond film electrodes associated with the square wave voltammetry (SWV) to detect the Hg-ion solution in the concentration range between 10 ppm and 0.001 ppm, wherein the Hg-ion oxidation current appears at the potential about 0.2V.

### EXAMPLE 5

### Analysis of Ag-Ion Concentration Using Conductive Diamond Film Electrode

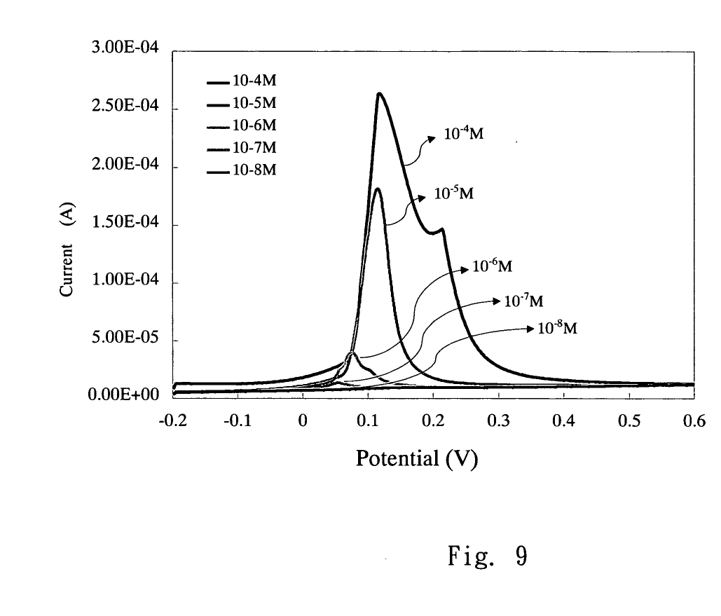

FIG. 9 is an electrochemical analysis diagram illustrating using conductive diamond film electrodes associated with the square wave voltammetry (SWV) to detect the Ag-ion solution in the concentration range between 10⁻⁴M and 10⁻⁸M, wherein the Ag-ion oxidation current appears at the potential about 0.1V.

### EXAMPLE 6

### Analysis of Pentachlorophenol Concentration Using Conductive Diamond Film Electrode

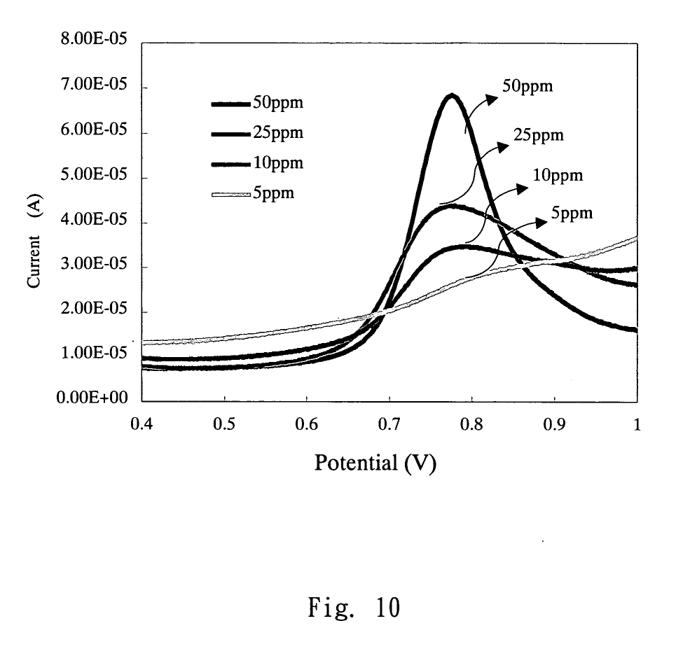

FIG. 10 is an electrochemical analysis diagram illustrating using conductive diamond film electrodes associated with the square wave voltammetry (SWV) to analyze the concentration of pentachlorophenol, wherein the pentachlorophenol exhibits the irreversible oxidation reaction at +0.8V with the detection concentration between 5 ppm and 50 ppm.

In a summary, the present invention provides an electrochemical analysis method using conductive diamond film electrode, which employs the conductive diamond film material as the electrode associated with the square wave voltammetry of pulsed voltammetry to detect the concentration of heavy metal and organic matters in the solution. Because the conductive diamond electrode can provide wider and stable potential window for aqueous solution, it can eliminate the electrochemical interference problem caused by the electrolysis reaction of water in the past. Moreover, because of the higher surface drainage, it can continuously keep the activation function without the surface poison by the attachment of pollutants, and have higher application endurance. Thus, the presented method has very high industrial application value.

The present invention has been disclosed by the preferred embodiments as the above, but they are not used as the limitation of the present invention. The skilled in the art can make various change and modifications without departing from the spirit and range in the present invention. Therefore, the protection range of the present invention is defined by the following claims.

1. A method for detecting trace amount of matters using the pulsed voltammetry, comprising the steps of:
providing a working electrode and a reference electrode, wherein the material of the working electrode is a conductive diamond film electrode;
immersing the working electrode and the reference electrode into a solution;
sweeping the potential of the working electrode to the potential of more negative than the balance potential for the trace amount of matters in the solution;
conducting positive sweeping on the potential of the working electrode using the square wave voltammetry (SWV) of pulsed voltammetry (PV); and
recording the amount of current occurred during potential change to detect the concentration of trace amount of matters in the solution.

2. The method according to claim 1, wherein the conductive diamond film electrode uses the chemical vapor deposition (CVD) to form the diamond film on the substrate surface.

3. The method according to claim 2, wherein the substrate for the conductive diamond film electrode includes Ti, Si, Zr, Mo, Ta, W, or other metal or alloy.

4. The method according to claim 2, wherein the substrate for the conductive diamond film electrode is Ti.

5. The method according to claim 2, wherein the diamond film is the p-type or n-type doping diamond film.

6. The method according to claim 5, wherein the p-type conductive diamond film electrode is B-doped conductive diamond film electrode.

7. The method according to claim 5, wherein the n-type conductive diamond film electrode is P-doped conductive diamond film electrode or N-doped conductive diamond film electrode.

8. The method according to claim 1, wherein sweeping the potential of working electrode to the potential more negative than the balance potential is to deposit or attach the trace amount of matters on the electrode surface.

9. The method according to claim 1, wherein the trace amount of matters include metal or organic compounds.

10. The method according to claim 1, wherein the pulsed frequency (f) of the square wave voltammetry (SWV) is 30-150 Hz.

11. The method according to claim 1, wherein the pulse potential difference (ΔEₚ) of the square wave voltammetry (SWV) is 20-150 mV.

12. The method according to claim 1, wherein the step potential difference (ΔE_{S}) of the square wave voltammetry (SWV) is 2-10 mV.

13. The method according to claim 1, wherein the pH value of the square wave voltammetry (SWV) is 4-7.

14. A method for detecting trace amount of matters using pulsed voltammetry, which uses the conductive diamond film electrode associated with the square wave voltammetry (SWV) of pulsed voltammetry (PV) to detect the concentration of heavy metal and/or organic matters in the solution, wherein the detection conditions for the square wave voltammetry (SWV) include: the pulsed frequency (f) is 30˜150 Hz; pulse potential difference (ΔEₚ) is 20˜150 mV; the step potential difference (ΔE_{S}) is 2˜10 mV; and, the pH value is 4˜7.

15. The method according to claim 14, wherein the substrate for the conductive diamond film electrode includes Ti, Si, Zr, Mo, Ta, W, or other metal or alloy.

16. The method according to claim 14, wherein the diamond film is the p-type or n-type doping diamond film.

17. The method according claim 16, wherein the p-type conductive diamond film electrode is B-doped conductive diamond film electrode.

18. The method according to claim 16, wherein the n-type conductive diamond film electrode is P-doped conductive diamond film electrode or N-doped conductive diamond film electrode.
